(19) United States
(12) Patent Application Publication
(10) Pub. No.: US 2025/0214706 A1
(43) Pub. Date: Jul. 3, 2025

(54) ATTACK AIRCRAFT WITH AN AMMUNITION RACK PROTECTED BY A MOVABLE COVER

(71) Applicant: Tusas- Turk Havacilik Ve Uzay Sanayii Anonim Sirketi, Kahramankazan, Ankara (TR)

(72) Inventors: Hasan AKMAN, Kahramankazan, Ankara (TR); Ali AKCAY, Kahramankazan, Ankara (TR); Mehmet Bahadir AYATA, Kahramankazan, Ankara (TR)

(73) Assignee: Tusas- Turk Havacilik Ve Uzay Sanayii Anonim Sirketi, Kahramankazan, Ankara (TR)

(21) Appl. No.: 18/852,586

(22) PCT Filed: Mar. 28, 2023
(86) PCT No.: PCT/TR2023/050296

§ 371 Date: Sep. 30, 2024

(30) Foreign Application Priority Data
Mar. 31, 2022 (TR) 2022/005030

(51) Int. Cl. B64D 7/06

(52) U.S. Cl. CPC B64D 7/06

(57) ABSTRACT

This invention relates to a body (2), at least one rack (3) on the body (2) in which ammunition (M) is located and carried, at least one cover (4) protecting the rack (3) from aerodynamic effects, a first position (I) in which the ammunition (M) is located in the rack (3) and the covers (4) are closed, a second position (II) in which the ammunition (M) is located outside the rack (3) and the covers (4) are opened, and an actuator (5) enabling the ammunition (M) to be rotatingly brought from the first position (I) to the second position (II).

This invention relates to an attack aircraft that carries ammunition.

The ammunition in next-generation fighter aircraft is located within the aircraft. Ammunition is carried in main gun racks and side gun racks before being fired. Air-to-ground ammunition is generally used in main gun racks, whereas air-to-air ammunition in side gun racks. The ammunition in the main gun racks is usually pushed and dropped with a direct pneumatic system. In side gun racks, in turn, the ammunition needs to be taken out. The reason for this is that there is a smart warhead on the head of the ammunition, this warhead detecting other air vehicles and then advancing towards the target.

In the Chinese patent application document CN108216560A, which is included in the known state of the art, a laterally opened aircraft weapon cabin door mechanism is mentioned. A laterally opened aircraft weapon cabin door mechanism comprising a door, a beam, a rod and a rotary actuator forms a four-bar coupling mechanism. The beam is rotated by driving the actuator. The coupling point of the beam and the door is located in the middle of the width of the door. The coupling point of the rod and the door is located within the width of the door, and the rod in the body of the coupling point is located in the width of the weapon chamber.

Thanks to an attack aircraft developed by this invention, a single actuator is enabled both to open the ammunition rack cover and to take the ammunition out of the rack.

One object of this invention is to provide a lighter and simpler system for taking ammunition out of racks in attack aircraft.

Another object of this invention is to open the covers of the lateral racks and take out ammunition with a simpler control algorithm in attack aircraft.

A further object of this invention is to minimize the negative effects of aeroacoustic loads on the equipment located inside when the covers are closed back after the ammunition is taken out of the lateral racks in the attack aircraft.

An attack aircraft realized to achieve the object of the invention and defined in the first claim and in the claims dependent thereon comprises a body and at least one rack in the body, in which ammunition (M) is carried. There is at least one cover that protects the rack from aerodynamic effects and closes it to the outside. There is a first position (I) in which the ammunition (M) is located in the rack and the covers are closed, and a second position (II) in which the ammunition (M) is located outside the rack and the covers are opened. An actuator enables the ammunition (M) to be brought from the first position (I) to the second position (II) by making a rotational movement. The ammunition (M) in fifth-generation fighter aircraft is stored and transported inside the aircraft. The ammunition (M) carried in the rack is moved by the actuator. The ammunition (M) is located in the aircraft in the first position (I) during which they are within the rack and the covers are closed, or in the second position (II) during which they are completely outside the rack and the covers are opened.

The attack aircraft of the invention comprises a transmission mechanism that transmits the movement it receives from the actuator to the cover. The transmission mechanism is located in the rack with one end thereof being connected to the cover and the other end to the actuator. A single actuator triggers simultaneously the cover and the ammunition (M). By means of the transmission mechanism actuated by the actuator, both the cover is moved and the ammunition (M) is taken out of the rack. With a single actuator line, an advantage is ensured in terms of placement and weight. At the same time, the control algorithm is simplified.

In an embodiment of the invention, the attack aircraft comprises a third position (III) in which ammunition (M) is located outside the rack and the cover is closed. By providing a first drive to the transmission mechanism, the actuator enables the ammunition (M) and the cover to be brought from the first position (I) to the third position (III) in a synchronized manner. In the third position (III), when the ammunition (M) is taken out of the rack, the cover is closed. When the covers opened at high speeds remain open until the ammunition (M) is launched, they create an effect similar to a flight control surface for many equipment in the rack. At the same time, the equipment inside is exposed to aeroacoustic vibrations, and in this case, their lifespan is reduced. When the ammunition (M) is carried outside, the adverse conditions mentioned in the third position (III) where the cover is closed are eliminated.

In an embodiment of the invention, the attack aircraft comprises a cover (4) that is rotatingly opened while the ammunition (M) is brought from the first position (I) to the second position (II) and rotatingly closed while the ammunition (M) is brought from the second position (II) to the third position (III).

The cover (4) is rotatingly opened and is rotatingly closed back after the ammunition (M) is taken out. The opening and closing of the cover (4) is carried out by means of a transmission mechanism (5). With the same actuator (5), the ammunition (M) and the cover (4) are moved synchronously.

In an embodiment of the invention, the attack aircraft comprises multiple transmission elements located on the transmission mechanism at user-predetermined angular values. While the ammunition (M) is brought from the first position (I) to the third position (III), the transmission elements that move at certain angular values are located in a way that they do not contact with the ammunition (M). The transmission elements are triggered by the actuator. The transmission elements transmit the movement transmitted by the actuator to the cover by means of interconnection points and/or by means of rotational movement around each other. The transmission elements that compose the transmission mechanism enables the cover to be opened or closed.

In an embodiment of the invention, the attack aircraft comprises a rack wall located on the outer surface of the aircraft, through which the rack is exposed to aerodynamic effects. There is a carrier that carries the ammunition (M) without contacting the rack wall and has an eccentric form. Thanks to its curved form, the carrier enables the ammunition (M) to move easily without hitting the transmission mechanism while the cover is opened and closed. While in the third position (III), during which the ammunition (M) is completely outside and the cover is closed, there is left a gap between the rack wall and the carrier.

In an embodiment of the invention, the attack aircraft comprises a carrier that is located against the aerodynamic surfaces such as the side walls, which are the first surface to experience aerodynamic effects, or side surfaces that form the periphery of the rack. There is at least one protrusion integral with the carrier, extending from the carrier and contacting the aerodynamic surface. Thanks to the protrusion, the rack is completely closed to the outside and protected from aerodynamic effects.

In an embodiment of the invention, the attack aircraft comprises a transmission mechanism in the form of a four-bar mechanism. The four-bar mechanism consists of simple movable joints that form a closed chain link with the four joints. The length, position, and mutual alignment of the transmission elements in the transmission mechanism affect the motion output of the transmission mechanism. One point in each of the four rod mechanisms is fixed, and secured to the aircraft, and three arms are provided to form a closed loop.

In an embodiment of the invention, the attack aircraft comprises a transmission mechanism in the form of an arm pendulum four-bar mechanism. While one of the limbs connected to the fixed limb in the arm pendulum mechanism makes a full rotation, the other makes a swinging movement. Thanks to this mechanism which can move reversibly, the cover of the rack can be opened and closed.

In an embodiment of the invention, the attack aircraft comprises a first transmission element with one end being connected to the actuator and transmitting the rotational movement received from the actuator to its other end, thereby providing movement to the transmission mechanism, an I-shaped second transmission element with one end being connected to the first transmission element and triggered by the movement of the first transmission element, and a third transmission element with one end being connected to the second transmission element, transmitting the movement received from the second transmission element to its other end by rotating at the point by which it is connected to the rack, thereby enabling the cover to be opened or closed. The transmission mechanism is composed of three transmission elements and is fixed to the aircraft from one point. The first transmission element is actuated by the actuator. The first transmission element actuates the second transmission element, and the second transmission element triggers the third transmission element. The third transmission element rotates the cover from a rigid point fixed to the cover by means of the movement it receives.

The guide system realized to achieve the object of the present invention is shown in the attached figures, wherein;

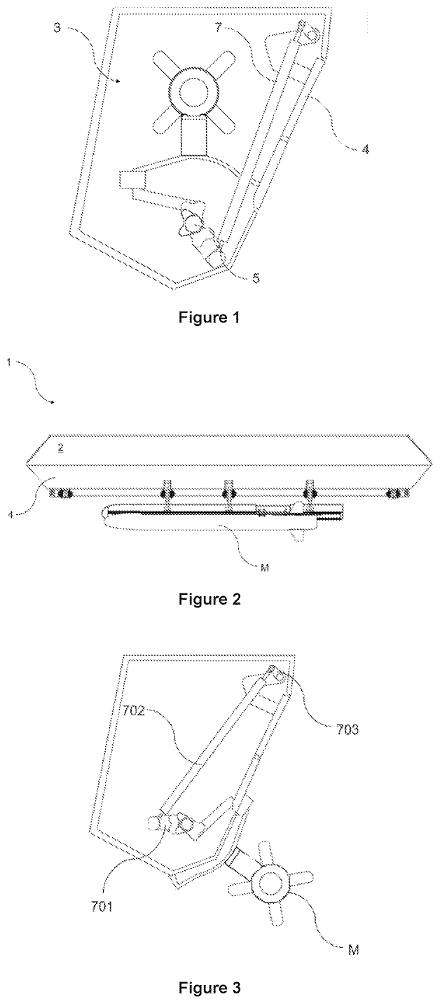

FIG. 1 is a schematic view of the ammunition (M) in the first position (I).

FIG. 2 is a side view of the ammunition (M) in the second position (II).

FIG. 3 is a schematic view of the ammunition (M) in the third position (III).

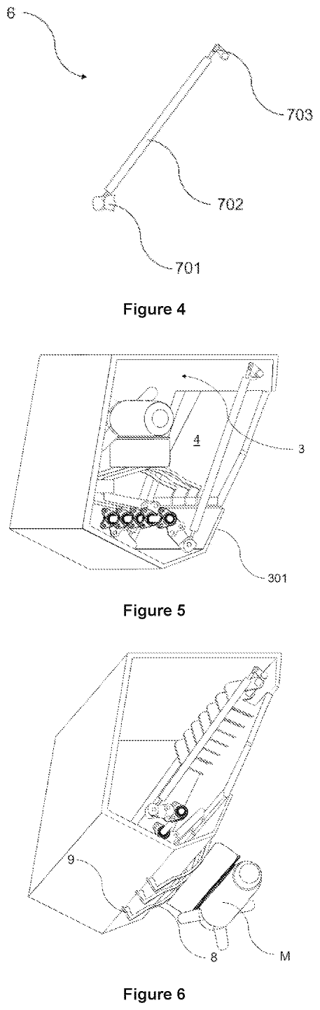

FIG. 4 is a schematic view of a transmission mechanism.

FIG. 5 is a perspective view of the ammunition (M) in the first position (I).

FIG. 6 is a perspective view showing the ammunition (M) in the third position (III).

The parts illustrated in figures are individually assigned a reference numeral and the corresponding terms of these numbers are listed below.
1. Attack aircraft
2. Body
3. Rack
   301. Rack wall
4. Cover
5. Actuator
6. Transmission mechanism
7. Transmission element
   701. First transmission element
   702. Second transmission element
   703. Third transmission element
8. Eccentric carrier
9. Protrusion
(M) Ammunition
(I) First Position
(II) Second Position
(III) Third Position

The attack aircraft (1) comprises a body (2), at least one rack (3) on the body (2) in which ammunition (M) is located and carried, at least one cover (4) protecting the rack (3) from aerodynamic effects, a first position (I) in which the ammunition (M) is located in the rack (3) and the covers (4) are closed, a second position (II) in which the ammunition (M) is located outside the rack (3) and the covers (4) are opened, and an actuator (5) enabling the ammunition (M) to be rotatingly brought from the first position (I) to the second position (II). (FIG. 1, FIG. 2)

The attack aircraft (1) of the invention comprises a transmission mechanism (6) located in the rack (3) so as to be connected to the cover (4) from one end thereof and to the actuator (5) from the other end thereof, transmitting the movement it receives from the actuator (5) to the cover (4), thereby enabling the cover (4) to be moved, the actuator (5) simultaneously triggering the cover (4) and the ammunition (M) by means of the transmission mechanism (6), thereby enabling the ammunition (M) to be moved. (FIG. 4, FIG. 5)

The attack aircraft (1) comprises at least one rack (3) in which ammunition (M) is located. The ammunition (M) in fifth-generation attack aircraft (1) is stored and carried inside the rack (3). Main ammunition (M) racks (3) and side ammunition (M) racks (3) are provided. Air-to-ground ammunition (M) is carried in the main ammunition (M) rack (3) and is pushed and dropped by a pneumatic system. In the side ammunition (M) racks (3), the ammunition (M) needs to be taken out. There is a first position (I) in which the ammunition (M) is located in the rack (3) and the covers (4) are closed, and a second position (II) in which the ammunition (M) is located outside the rack (3) and the covers (4) are opened. The ammunition (M) carried in the rack (3) is moved by the actuator from the first position (I) to the second position (II).

A transmission mechanism (6) is located in the rack (3) so that it is connected to the cover (4) from one end thereof and to the actuator (5) from the other end thereof. Thanks to the transmission mechanism (6) actuated by the actuator (5), the cover (4) is enabled to be moved without using a second actuator (5). At the same time, the transmission mechanism (6) and the actuator (5) synchronously trigger the cover (4) and the ammunition (M), thereby enabling the ammunition (M) to be moved. Thanks to the actuator (5) and transmission mechanism (6), an advantage is provided in terms of weight and the placement of the equipment in the rack. At the same time, a simpler system is formed for moving the ammunition (M) and taking it out from the rack (3).

In an embodiment of the invention, the attack aircraft (1) comprises a third position (III) in which the ammunition (M) is located outside the rack (3) and the cover (4) is closed, the actuator (5) enabling the ammunition (M) and the cover (4) to be brought simultaneously from the first position (I) to the third position (III) by triggering the transmission mechanism (6). The actuator (5) actuates the transmission mechanism (6). While the transmission mechanism (6) enables the cover (4) to be moved, it is enabled to bring the ammunition (M) from the first position (I) to the third position (III) in a simultaneous manner. In the third position (III), when the ammunition (M) is taken out from the rack (3), the cover (4) is closed. Thus, adverse conditions such as vibration, noise, damage to equipment are minimized.

In an embodiment of the invention, the cover (4) is rotatingly opened while the ammunition (M) is brought from the first position (I) to the second position (II) and rotatingly closed while the ammunition (M) is brought from the second position (II) to the third position (III), the transmission mechanism (5) enabling the cover (4) to be opened, the ammunition (M) being triggered simultaneously with the same actuator (5), and a cover (4). The cover (4) performs its opening and closing movement by making a rotational movement.

In an embodiment of the invention, the attack aircraft (1) comprises multiple transmission elements (7) located on the transmission mechanism (6) at user-predetermined angular values, triggered by the actuator (5) so as to be moved without contacting the ammunition (M) as the ammunition (M) switches from the first position (I) to the third position (III), the transmission mechanism (6) transmitting the movement transmitted by the actuator (5) to the cover (4) by means of the multiple transmission elements' (7) interconnection points and/or rotational movements around each other, thereby enabling the cover (4) to be opened or closed. Thanks to the transmission elements (7) that form the transmission mechanism (6) at certain angular values, the ammunition (M) and the transmission mechanism (6) are located such that they will not collide while the ammunition (M) is moving. First the cover (4) is opened by the transmission mechanism (6). During a full rotation of the cover (4), the ammunition (M) is taken out. Then, the cover (4) is closed by making a rotational movement in the opposite direction. The transmission elements (7) transmit the movement to the cover (4) by means of interconnection points and/or rotational movement around each other.

In an embodiment of the invention, the attack aircraft (1) comprises a rack wall (301) of the rack (3) that is exposed to aerodynamic effects, the carrier (8) with a curved form being located without contacting the rack wall (301), ammunition (M) being located thereon, and leaving a gap between itself and the rack wall (301) when the ammunition (M) is in the third position (III). The rack wall (301) is located on the outer surface of the rack (3) where it is exposed to aerodynamic effects. The ammunition (M) is located on the curved carrier (8) which has an eccentric form and does not contact the rack wall (301) when the ammunition (M) is in the third position (III). When the cover (4) is opened, it becomes wider due to the form of the carrier (8) and is opened accordingly. (FIG. 6)

In an embodiment of the invention, the carrier (8) of the attack aircraft (1) is mutually located with the aerodynamic surface, and at least one protrusion (9) being included that is single-piece with the carrier (8), extending from the carrier (8) and contacting the aerodynamic surface, thereby protecting the rack (3) from aerodynamic effects. Thanks to the protrusion (9), air intake of the rack (3) is completely prevented. (FIG. 6)

In an embodiment of the invention, the attack aircraft (1) comprises a transmission mechanism (6) in the form of a four-bar mechanism. Thanks to the transmission mechanism (6), only a single actuator (5) both opens the cover (4) and moves the ammunition (M). (FIG. 4)

In an embodiment of the invention, the attack aircraft (1) comprises a transmission mechanism (6) in the form of an arm pendulum four-bar mechanism. Thanks to the transmission mechanism (6) in the form of an arm pendulum four-bar mechanism, the cover (4) is opened, the ammunition (M) is taken out of the rack (3) and the cover (4) is closed again.

In an embodiment of the invention, the attack aircraft (1) comprises a transmission mechanism (6) composed of a first transmission element (701) with one end being connected to the actuator (5) and transmitting the rotational movement received from the actuator (5) to its other end, thereby providing movement to the transmission mechanism (6), an I-shaped second transmission element (702) with one end being connected to the first transmission element (701) and triggered by the movement of the first transmission element (701), and a third transmission element (703) with one end being connected to the second transmission element (702), transmitting the movement received from the second transmission element (702) to its other end by rotating at the point by which it is connected to the rack (3), thereby enabling the cover (4) to be opened or closed. The transmission mechanism (6) is composed of the first transmission element (701), the second transmission element (702) and the third transmission element (703). The transmission elements (7) in the transmission mechanism (6) perform the opening or closing movement of the cover (4) based on the angular values predetermined by the user. Thus, the ammunition (M) can be taken out of the rack (3). (FIG. 3)

1. An attack aircraft (1) comprising a body (2), at least one rack (3) located on the body (2) in which ammunition (M) is located and carried, a cover (4) protecting the rack (3) from aerodynamic effects, a first position (I) in which the ammunition (M) is located in the rack (3) and the cover (4) is closed, a second position (II) in which the ammunition (M) is located outside the rack (3) and the cover (4) is open, and an actuator (5) for enabling the ammunition (M) to be rotatingly brought from the first position (I) to the second position (II), and a third position (III) in which the ammunition (M) is located outside the rack (3) and the cover (4) is closed, the actuator (5) for enabling the ammunition (M) and the cover (4) to be brought simultaneously from the first position (I) to the third position (III) by triggering the transmission mechanism (6) characterized by a transmission mechanism (6) located in the rack (3) so as to be connected to the cover (4) from one end thereof and to the actuator (5) from the other end thereof, transmitting the movement it receives from the actuator (5) to the cover (4), thereby for enabling the cover (4) to be moved, the actuator (5) simultaneously triggering the cover (4) and the ammunition (M) by means of the transmission mechanism (6), thereby for enabling the ammunition (M) to be moved.

2. (canceled)

3. An attack aircraft (1) according to claim 1, characterized by the cover (4) being rotatingly opened while the ammunition (M) is brought from the first position (I) to the second position (II) and rotatingly closed while the ammunition (M) is brought from the second position (II) to the third position (III), the transmission mechanism (5) for enabling the cover (4) to be opened, the ammunition (M) being triggered simultaneously with the same actuator (5), and a cover (4).

4. An attack aircraft (1) according to claim 1, characterized by multiple transmission elements (7) located on the transmission mechanism (6) at user-predetermined angular values, triggered by the actuator (5) so as to be moved without contacting the ammunition (M) as the ammunition (M) switches from the first position (I) to the third position (III), the transmission mechanism (6) transmitting the movement transmitted by the actuator (5) to the cover (4) by means of the multiple transmission elements' (7) interconnection points and/or rotational movements around each other, thereby for enabling the cover (4) to be opened or closed.

5. An attack aircraft (1) according to claim 1, characterized by a rack wall (301) of the rack (3) that is exposed to aerodynamic effects, a carrier (8) with a curved form being located without contacting the rack wall (301), ammunition (M) being located thereon, and leaving a gap between itself and the rack wall (301) when the ammunition (M) is in the third position (III).

6. An attack aircraft (1) according to claim 5, characterized by the carrier (8) being mutually located with the aerodynamic surface, and at least one protrusion (9) being single-piece with the carrier (8), extending from the carrier (8) and contacting the aerodynamic surface, thereby protecting the rack (3) from aerodynamic effects.

7. An attack aircraft (1) according to claim 1, characterized by the transmission mechanism (6) being in the form of a four-bar mechanism.

8. An attack aircraft (1) according to claim 1, characterized by the transmission mechanism (6) being in the form of an arm pendulum four-bar mechanism.

9. An attack aircraft (1) according to claim 1, characterized by the transmission mechanism (6) being composed of a first transmission element (701) with one end being connected to the actuator (5) and transmitting the rotational movement received from the actuator (5) to its other end, thereby providing movement to the transmission mechanism (6), an I-shaped second transmission element (702) with one end being connected to the first transmission element (701) and triggered by the movement of the first transmission element (701), and a third transmission element (703) with one end being connected to the second transmission element (702), transmitting the movement received from the second transmission element (702) to its other end by rotating at the point by which it is connected to the rack (3), thereby for enabling the cover (4) to be opened or closed.
